(19) United States
(12) Patent Application Publication
(10) Pub. No.: US 2020/0143237 A1
(43) Pub. Date: May 7, 2020

(54) DETECTION OF VEHICLE RIDING BEHAVIOR AND CORRESPONDING SYSTEMS AND METHODS

(71) Applicant: Ford Global Technologies, LLC, Dearborn, MI (US)

(72) Inventors: Alan Gordon, Menlo Park, CA (US); Sagar Kumar Regmi, Newark, CA (US)

(73) Assignee: Ford Global Technologies, LLC, Dearborn, MI (US)

(21) Appl. No.: 16/183,546

(22) Filed: Nov. 7, 2018

(51) Int. Cl. G06N 3/08; G06N 20/00

(52) U.S. Cl. CPC G06N 3/08; G06N 20/00

(57) ABSTRACT

In various embodiments, the present disclosure relates to systems, methods, and computer-readable media for the detection of vehicle (e.g., a scooter) riding behavior. In particular, a method is described, the method including: determining first sensor data received from one or more sensors associated with a device, wherein the first sensor data is associated with a vehicle and with a time domain; determining, by the at least one processor, based on the first sensor data, second sensor data associated with a frequency domain, wherein to determine the second sensor data comprises to perform a Fourier transform on the first sensor data to determine Fourier coefficients associated with the first sensor data; and determining, by the at least one processor, based on the Fourier coefficients, using a machine learning algorithm, a type of the vehicle.

### TECHNICAL FIELD

The present disclosure relates to systems, methods, and computer-readable media for the detection and control of vehicle riding behavior.

### BACKGROUND

Particularly in urban environments people tend to use a variety of transportation methods. A user may, at times, use a privately-owned vehicle, a taxi-cab, a ride-share such as Uber, public transportation such as a bus or train, a bicycle, or the increasingly popular, stand-up eScooters of the type offered for short-term dock-less rentals. Each of these transportation modes has trade-offs. For example, privately-owned vehicles are the most convenient, private, and safe mode of transportation for the commuter, but may use more energy than some other modes of transportation and may be associated with traffic congestion. Many cities are interested in being able to track the number of people using eco- and congestion friendly transportation modes such as bicycles or eScooters.

### BRIEF DESCRIPTION OF THE DRAWINGS

FIG. 1A shows a diagram of an example environmental context, in accordance with example embodiments of the disclosure.

FIG. 1B shows a diagram of a user device in accordance with example embodiments of the disclosure.

FIG. 2A shows a plot of example acceleration data, in accordance with example embodiments of the disclosure.

FIG. 2B shows a plot of an example Fourier transform of the acceleration data shown in FIG. 2A, in accordance with example embodiments of the disclosure.

FIG. 3A shows a plot of example acceleration data for an example scooter, in accordance with example embodiments of the disclosure.

FIG. 3B shows a plot of example rotation data, in accordance with example embodiments of the disclosure.

FIG. 3C shows a plot of an example first component of total rotation data, in accordance with example embodiments of the disclosure.

FIG. 3D shows a plot of an example second component of a total rotation data, in accordance with example embodiments of the disclosure.

FIG. 3E shows a plot of an example third component of a total rotation data, in accordance with example embodiments of the disclosure.

FIG. 4A shows a plot of example acceleration data for an electric bike operating on a road, in accordance with example embodiments of the disclosure.

FIG. 4B shows a plot of example rotation data, in accordance with example embodiments of the disclosure.

FIG. 4C shows a plot of an example first component of total rotation data, in accordance with example embodiments of the disclosure.

FIG. 4D shows a plot of an example second component of total rotation data, in accordance with example embodiments of the disclosure.

FIG. 4E shows a plot of an example third component of total rotation data, in accordance with example embodiments of the disclosure.

FIG. 5A shows a diagram of an exemplary system for reward remittance including a cryptocurrency payment network, in accordance with example embodiments of the disclosure.

FIG. 5B shows a diagram of an exemplary system for reward remittance including a cryptocurrency payment network, in accordance with example embodiments of the disclosure.

FIG. 6 shows a diagram illustrating a blockchain, in accordance with example embodiments of the disclosure.

FIG. 7 is a functional diagram illustrating details of each block and transaction in the blockchain of FIG. 6, in accordance with example embodiments of the disclosure.

FIG. 8 shows a diagram of an example flow chart, in accordance with example embodiments of the disclosure.

FIG. 9 is a schematic illustration of an example server architecture for one or more server(s) in accordance with one or more embodiments of the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Scooters (e.g., standup electronic scooters or eScooters) increasingly are being used to provide last-mile transportation, for example, in dense urban environments. For example, dockless eScooter rentals are being provided in a growing number of cities. However, the presence of such scooters has not been universally welcomed in some localities, as the scooters may some cause management problems for city and municipal regulatory agencies. For example, some cities have banned scooter use in certain areas; further, parties who are providing such scooters may be forced to remove their scooters from streets and local environments and instead apply for permits. To better facilitate and control usage of scooters, computers may need to be able to identify modes of transportation without requiring inefficient use of device resources.

Scooters in such localized environments as described above may face at least the following issues: (1) The scooters may be dockless and may be left in locations where the scooters block areas (e.g., sidewalks) and may thereby create hazards. In some cases, city dwellers may vandalize the scooters in areas where the scooters find prevalent usage. (2) The scooters may be ridden in an unsafe manner. For example, in many jurisdictions, riding a scooter may require a user to have a driver's license and a helmet; further, it may be illegal to ride scooters in certain areas, such as on sidewalks.

Parties may want to offer incentives for those people who use alternative transportation modes such as scooters, and where other transportation modes have drawbacks, parties may benefit from controlling and channeling scooter scotter use. The smartphones that people carry may include sensors which may be used to detect the transportation mode that a commuter is using. Detection of a commuter's transportation mode is the first step to being able to control, incentivize, and optimize the use of all the available transportation modes to reduce congestion and pollution and improve the quality of life in cities.

What is considered safe for riding a scooter may be different than for other modes of transportation such as cars or bicycles. Therefore, to regulate the use of scooters to improve user safety, a computer may need to be able to detect when a scooter is being used rather than some other mode of transportation. While a person could simply see a scooter and identify it as such, it is not reasonable on a large scale for human operators to monitor all scooter usage. Instead, computers may monitor use of different modes of transportation and provide controls and incentives to influence the use of different modes of transportation. Once a mode of transportation is identified, criteria applicable to that mode of transportation may be used to control the use of that mode of transportation. For example, if a car is identified, the rules for driving the car may be different than the rules for driving a scooter, and a computer may provide incentives, monitor use according to the applicable restrictions, and/or provide commands to devices to facilitate use of the car.

While a computer may distinguish between the use of a car and a scooter (e.g., driving speeds may be significantly disparate), some modes of transportation may be more difficult for a computer to identify. For example, bikes and scooters may operate at similar speeds, so a computer may struggle to differentiate between bike and scooter usage. However, the differentiation may be important because use criteria may be different for the different modes of transportation. One way that computers may identify a mode of transportation may include using gyroscopes and accelerometers of user devices. If a user is riding a bike and has a smart phone, for example, the sensors on the smart phone may provide velocity, acceleration, and location data which may be used by a computer to determine that a user is riding a bike rather than a car, for example. Because such captured data from a device may be similar for bike and scooter usage, though, a computer may need to consider other information to distinguish between bike and scooter usage. Also, velocity data provided by user devices may rely on location data such as global positioning services (GPS), which may not be reliable in some situations and requires significant battery usage. Thus, some existing computer-based methods of identifying transportation modes may be inaccurate and may require inefficient use of device resources, such as power and processing.

Some existing systems may determine modes of transportation based on device-specific information (e.g., information captured by device sensors), however, some existing systems may be unable to distinguish between scooter transportation and other modes of transportation. A person riding a scooter may exhibit a velocity profile (e.g., based on data detected by user device sensors) similar to that of a bicycle user. Acceleration profiles between scooters and bicycles also may be similar because, for example, a scooter rider may lean to create centripetal force to cause a scooter to turn. However, because scooter riders do not have to pedal scooters as a bicycle rider pedals a bicycle, body movement of a scooter rider may be less than body movement of a bicycle rider, and corresponding frequency data (e.g., when time-domain data such as acceleration data is converted to the frequency domain) between scooter and bicycle riders may exhibit more distinct differences. Longitudinal accelerations of scooters may be faster than those of a bicycle, so longitudinal acceleration data may help a computer distinguish between scooter transportation and bicycle transportation.

Therefore, it may be beneficial to improve a computer's ability to distinguish between scooter transportation and other similar types of transportation by using more reliable information which conserves device resources One way to improve computer recognition of different modes of transportation while improving device functionality is to analyze frequency data, which may be affected by user movement (e.g., a user pedaling a bicycle). The use of frequency data may not only improve the ability of a computer to distinguish between scooter transportation and other modes of transportation, but also provides tangible benefits with respect to device resources (e.g., user devices providing data used to identify a mode of transportation may use less power). Thus, aspects of the disclosure do not merely execute a manual detection of scooter usage with a computer, but also provide an unconventional use of some device-detected information over other types of device-detected information to improve computer-based transportation detection and the use of device-specific resources.

In various aspects, the disclosed systems, methods, and apparatuses may be used by various entities such as regulatory agencies, to improve a computer's ability to detect, facilitate, and control the use of scooters. The improved ability of a computer to recognize and facilitate scooter usage may reduce the likelihood of entities banning or reducing scooter use, may improve transportation safety and traffic, and may improve device functionality by conserving device resources. In particular, embodiments of the disclosure are directed to a computer's ability to determine information including, but not limited to, (1) whether a scooter is being used, (2) where the scooters are being ridden, (3) how the scooters are ridden, and (4) how long the scooters are being ridden. Using this information, a computer may facilitate use of scooters, provide user incentives or penalties, and improve the use of devices which may provide relevant information used to identify scooter usage.

Embodiments of the disclosure may enable computers to detect and control aspects of the behavior of the users of scooters. For example, computers may distinguish between the use of scooters and other modes of transportation, influence the users of the scooters to, for example, leave their scooter at predetermined locations, ride scooters at certain locations and not others, and ride scooters at safe speeds. By enabling computer-based control, entities such as regulatory and governing agencies for a cities and municipalities may be more comfortable allowing scooters to serve as a form of transportation. This may thereby provide users with an additional environmentally-friendly transportation option, and may provide another accepted last mile transportation means.

Embodiments of the disclosure may (a) detect if a person is riding on an scooter and (b) determine if they are riding on the sidewalk or on the street. Further, if users are engaging in certain behaviors (e.g., if the users are riding on an scooter and on designated portions of an environment in a safe manner), one or more smart contracts running on a blockchain platform may be used to provide instance remittance of rewards (or penalties if said users are engaging in detrimental behaviors), for example, using cryptocurrencies or company-based tokens. In particular, smart contracts may refer to a computer protocol intended to digitally facilitate, verify, or enforce the negotiation or performance of a contract and may facilitate the performance of trackable and/or irreversible transactions without third parties. For example, a smart contract may be defined on the blockchain-based peer-to-peer network to remit or deduct a predetermined amount of cryptocurrency or tokens to a given user account associated with a rider of a scooter based on a near real time riding score of the user as determined by a user device (e.g., a mobile phone) and associated algorithms and applications described herein, in an automatic fashion.

In some aspects, the users of the vehicles such as scooters may download a related application on their user device (e.g., a mobile phone). In another aspect, the application may be configured to provide the users with potential rewards (e.g., monetary rewards, for example, in the form of cryptocurrency, and/or other promotional awards). Further, the users may, in some embodiments, be required to download such applications on their devices before being allowed to sign up with an scooter service.

Various user device (e.g., a mobile phones) may be equipped with sensors that can measure acceleration and rotation data along three spatial orthogonal axes. The frequency domain content of these signals, along with the speed and location (e.g., as determined by numerous factors, individually or in combination, such as global positioning system (GPS) signals and/or inertial system signal from the user device), may be used as features with a artificial-intelligence (AI)-based algorithm (e.g., a deep learning algorithm such as a convolutional neural network, CNN) to classify the current user's transportation mode (e.g., a train, bike, walking, running, scooter, and/or the like).

In another aspect, a behavior score of a user (also referred to variously as a rider, herein) of an vehicle (e.g., a scooter) may be calculated and used to determine whether a rider be penalized or rewarded. Further, in an aspect, if a given user received a repeated less-than-desirable behavior score (e.g., a behavior score less than a given threshold), the user may face certain consequences. For example, the user may no longer being allowed to sign up to use an scooter, or the user may be prevented from doing so for a period of time (e.g., six months). In another aspect, the control and implementation of such rules and consequences may be determined by one or more entities (e.g., governing agencies associated with cities in which the users are active), and implemented at least in part by using an application running on a user device (e.g., a mobile phone).

Various terms used throughout the specification and/or claims are defined below. In particular, in an embodiment, “blockchain” or “blockchain” may refer to a distributed database that keeps a growing list of data records. In another embodiment, each data record may be protected against tampering and revisions. blockchains may be used in association with public ledgers of transactions, and the record may be protected cryptographically.

In another embodiment, “computing node” may refer to a computational device with an internal address that can host a copy of a blockchain and the associated transactions, for example, as a part of a peer-to-peer network.

In one embodiment, a “hash function” may refer to a mathematical algorithm that may map an arbitrarily-large amount of data into a fixed-length size. In one embodiment, a given hash will always result from the same data, but modifying the data (e.g., changing a bit of the data) may change the hash. The values returned by the hash function are called a “hash”.

In one embodiment, “public ledger” may refer to a publicly accessible listing of transactions for the distributed database or blockchain.

In another embodiment, “digital currency” may refer to units of value that may be used as a form of payment for transactions, including financial transactions. Digital currency may include currency that is electronically generated by and stored within a computing device. Digital currency may be purchased using conventional forms of currency (e.g., fiat currency such as dollars or Euros) and generated with a specific value. Typically, the digital currency may not have a physical form of tender but may be accessible through a user computing device (e.g., mobile device) using a software application such as a digital wallet or mobile application.

In one embodiment, a “cryptocurrency payment network” may refer to one or more server computers that function to operate and maintain a cryptocurrency system. The cryptocurrency payment network may function to facilitate the generation/issuance and distribution of digital currency between the one or more server computers within the cryptocurrency payment network. The cryptocurrency payment network may also function to enable the performance of transactions between the server computers for the transfer or goods/services and/or the transfer of funds.

In the context of cryptocurrency systems, the term “node” may refer to a computing device within the cryptocurrency system. A node in a cryptocurrency system may be associated with and/or operated by a financial institution server computer of a financial institution (e.g., bank). Each node may have particular rights and restrictions associated with the node. For example, an issuer node may have the right to generate and issue digital currency within a cryptocurrency payment network, while a distributor node may have the right to distribute digital currency, but not generate or issue digital currency. Other nodes in the cryptocurrency payment network, such as merchants and users (e.g., consumers), may have the right to transfer digital currency.

In one embodiment, a “ledger of transactions” may refer to a compilation of data from previous transactions. The ledger of transactions may be a database or other comparable file structure that may be configured to store data from all previous transactions performed using a digital currency, including the date and time of the transaction, the transaction amount, and the participants of the transaction (e.g., the sender and the receiver of the transaction amount). In some embodiments, the ledger of transactions may include at least part of a blockchain, where a new block in the blockchain is algorithmically determined based on new transactions and previous blocks in the block chain. In some embodiments, each node within a cryptocurrency payment network may store their own copy of the ledger of transactions. In other embodiments, only some nodes may store their own copy of the ledger of transactions.

In one embodiment, a “digital certificate” may refer to data used as part of a verification process. A digital certificate may be used to send information to from one entity to another entity. The digital certificate may be used to verify that the entity sending a message is authentic. In some embodiments, a digital certificate may include data indicating a digital certificate version, a serial number, an algorithm identifier, a name of the issuing certificate authority (e.g., a management system), an expiration date, a copy of the node verification public key, and the digital signature of the issuing certificate authority so that a recipient (e.g., the node) can verify that the certificate is authentic.

In one embodiment, “digital signature” may refer to an electronic signature for a message. In some embodiments, the digital signature may be used to validate the authenticity of a transaction message sent within a cryptocurrency payment network. A digital signature may be a unique value generated from a message and a private key using an encrypting algorithm (e.g., a Rivest-Shamir-Adleman, RSA, algorithm). In some embodiments, a decrypting algorithm using a public key may be used to verify the signature. The digital signature may include, but not be limited to, a numeric value, an alphanumeric value, or any other type of data including a graphical representation.

In one embodiment, “key” may refer to a piece of data or information used for an algorithm. A key may be a unique piece of data and is typically part of a key pair where a first key (e.g., a private key) may be used to encrypt a message, while a second key (e.g., a public key) may be used to decrypt the encrypted message. The key may be a numeric or alphanumeric value and may be generated using an algorithm. A management system server computer in a cryptocurrency payment network may generate and assign a unique key pair for each node in the cryptocurrency payment network. In some embodiments, a key may refer to either a node verification key pair or a transaction key pair.

A transaction key pair may include a transaction public key and a transaction private key. The transaction key pair may be used by the nodes and/or payment entities to conduct transactions in the cryptocurrency payment network. The transaction key pair may be generated by one or more user devices (e.g., a server device, a mobile device, etc.) or may be generated by third-party device (e.g., a financial institution server computer) for a payment entity when an account with a given financial institution server computer is created. The transaction public key of a node may be distributed throughout a cryptocurrency payment network in order to allow for authentication of payment transaction messages signed using the private key of the node.

Further, a node verification key pair may include a node verification public key and a node verification private key. The node verification key pair may be used by the nodes and the management system to verify that a node is an issuer node or a distributor node. The node verification key pair may be generated by a given device (e.g., a management system server computer) in response to a request message from a node to be designated an issuer node or a distributor node in the cryptocurrency payment network. In other embodiments, the node verification key pair may be generated by a node (e.g., a financial institution server computer) and sent to the management system server computer. In some embodiments, a node verification public key may be functionally similar to a transaction public key. However, the node verification public key may only be distributed to the node associated with the node verification public key. In such embodiments, the node verification public key may be encrypted prior to being sent to the appropriate node.

In one embodiment, an “identifier” may refer to any information that may be used to identify information. In some embodiments, the identifier may be a special value generated randomly or according to a predetermined algorithm, code, or shared secret. For example, an account identifier may be used to uniquely identify an account. In some embodiments, the identifier may be one or more graphics, a token, a bar code, a QR code, or any other information that may be used to uniquely identify an entity.

In another embodiment, a “transaction” may include an exchange or interaction between two entities. In some embodiments, a transaction may refer to a transfer of value between two users (e.g., individuals or entities). A transaction may involve the exchange of monetary funds (e.g., digital currency), or the exchange of goods or services for monetary funds between two individuals or entities. In other embodiments, the transaction may be a purchase transaction involving an individual or entity purchasing goods or services from a merchant or other entity in exchange for monetary funds. In other embodiments, the transaction may be a non-financial transaction, such as exchanging of data or information between two entities, such as the transfer of data or information across a communications channel. Examples of non-financial transactions may include transactions for verifying an identity of a server computer and/or rights and restrictions associated with the server computer.

In one embodiment, a “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

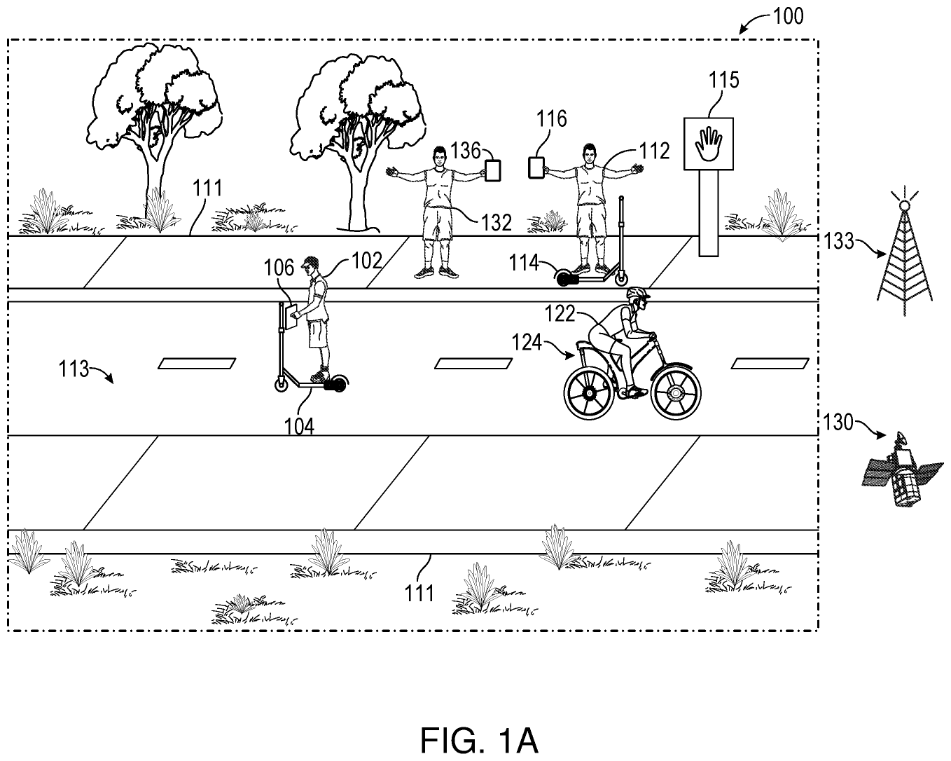

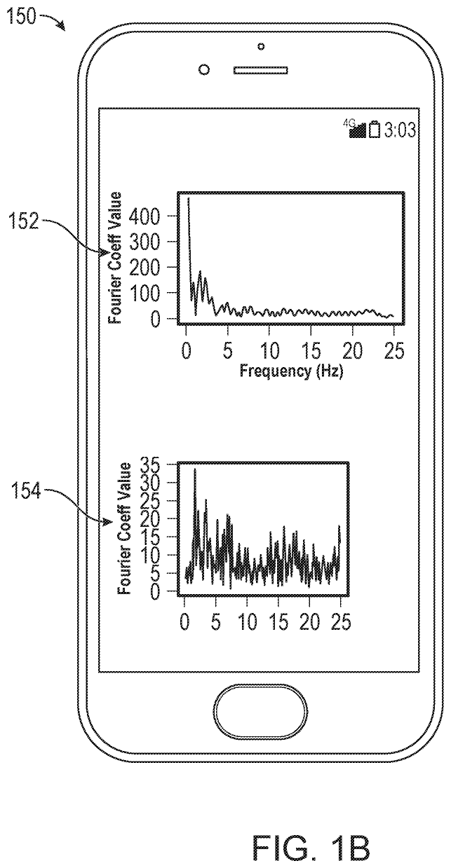

FIG. 1A shows a diagram of an example of an environmental context, in accordance with example embodiments of the disclosure. Environmental context 100 includes a user 102. In an aspect, the user 102 may include an individual that may be legally authorized to use a vehicle such as a scooter 104. In another aspect, the user 102 may ride a scooter 104 on the street 113. In various embodiments, the scooter 104 may include a human or machine powered scooter. Non-limiting examples of human-powered scooters include, but are not be limited to, an eccentric-hub scooter propelled by a standing rider making a bouncing motion, a kick scooter propelled by a standing rider pushing off the ground, and/or a knee scooter which may refer to a mobility device used as an alternative to a crutch. Non limiting examples of machine-powered scooters include, but are not be limited to, a sit-down scooter (e.g., similar to a motorcycle) with a step-through frame and a platform for the rider's feet and a seat, a mobility scooter including a wheelchair with a motor, a motorized scooter ridden standing up, and/or a self-balancing scooter which may include a compact self-balancing dicycle with an electric motor, ridden standing up.

In another aspect, scooters 104 may include electric scooters that may include have two hard small wheels, with a foldable chassis, made of any suitable material such as aluminum. Some scooters may include multiple wheels, or are made of plastic, or are large, or do not fold. Electric scooters may not have any gears. In another aspect, the electric scooters may have any suitable range, for example, anywhere from approximately 5 km to approximately 50 km, and may have a maximum speed of around 30 km/h.

In one aspect, the scooter 104 may be a part of a scooter-sharing system. In another aspect, the scooter-sharing system can refer to a service in which scooters are made available to use for short-term rentals. The sharing of scooters may be similar to carsharing or bicycle-sharing systems; with some scooter-sharing companies offering more than one type of vehicle via their service.

In another aspect, the scooter 104 may be dockless, meaning that the scooter 104 does not have a fixed home location, and may be dropped off and picked up from arbitrary locations in a given service area. This may make the scooter 104 a convenient mobility option for first-/last-mile mobility in urban areas. In some aspects, a smartphone mapping app running on a user's 102 device 106 may show nearby available scooters and may provide access to the scooter 104.

In another aspect, embodiments of the disclosure may be used to harvest of user-data when the user 102 is riding a vehicle such as a scooter 104. For example, GPS traceable vehicle commute patterns and usage habits may be collected and analyzed via a device on the scooter 104 and/or a user device 106, and the data may be provided to one or more government agencies, marketing companies or researchers. In one aspect, the scooter 104 and/or the user device 106 may include one or more devices, including, but not limited to, a GPS device, inertial sensors, timers, gyroscopes, microphones, cameras, and the like. Moreover, the scooter 104 devices may communicate with user device 106 to exchange data, or perform data fusion, for example, to increase the accuracy of collected data associated with the user 102 and/or the scooter 104. In another aspect, the user device 106 and/or scooter 104 device may communicate with one or more networks (not shown), such as wide area local network (WLAN), metropolitan LAN, Wi-Fi, cellular, and the like. Further, the user device 106 and/or scooter's 104 device(s) may upload such information to one or more cloud network (not shown) and/or databases for ease of access and analysis, for example, by one or more cloud-based machine learning algorithms, to be discussed below.

In another aspect, the environmental context 100 may include traffic controlling devices 115. In another aspect, the traffic controlling device 115 may include, but not be limited to, traffic lights, traffic signs, special markings, traffic cones, and the like. Such traffic controlling devices 115 may regulate how a given user 102 drives the scooter 104 in the environmental context 100.

In another aspect, the traffic controlling device 115 may include a geofence (not shown), which may be defined based at least in part by entity (e.g., an administrator of a city regulatory agency). In one aspect, geofences may include virtualized traffic controlling devices. These geofences may allow an administrator to specify, for example, whether a user (e.g., a user 102) should be paid a reward or issued a fine/toll based on whether the user enters or exits the geofence within a specified range of dates and times while using a particular transportation mode (e.g., a scooter 104). The rewards/fines/tolls may be added or deducted from a user's 102 cryptocurrency digital wallet using a blockchain smart contract, described further below. Such geofences may provide additional control to the various entities (e.g., city authorities) and enable the entities to dynamically control scooter traffic entering and/or leaving specific geofenced areas based on a timing factors (e.g., date and time of day) to account, and to accommodate for specific events.

An example of a geofence and its associated rules may include aspects of the following. For example, the geofence may have an associated name (e.g., Name: Stanford Research Park). Further, the geofence may have a recorded location (e.g., GPS Points: 37.406420, −122.155964, 37.400820, −122.138494, 37.399234, −122.134106, 37.413843, −122.140616, 37.419638, −122.135979, 37.422503, −122.141902). In one aspect, the geofence may have an accepted transportation mode (e.g., Transportation Mode: eScooter Street). The geofence may have a required user score (e.g., Rider Score: 90) to permit use. In one aspect, the geofence may have an accessibility description (e.g., Enter or Exit: Enter). In another aspect, the geofence may have a acceptable duration that a user may spend there (e.g., dwell time: 4 hours). In another aspect, the geofence may have an associated economic policy (e.g., Transaction Type: Payment). In another aspect, the geofence may have a payment for signup policy (e.g., Amount: 0.002 Ethereum coins (ETH). Further, the Geofence may have an accepted access times (e.g., Date/Times: Mon-Fri, 7:00 AM to 10:00 AM).

In particular, the rules specified above may indicate that a user (e.g., user 102) of the mobile application who has setup and registered an Ethereum digital wallet will receive a payment of 0.002 ETH (about $0.72 USD as of Aug. 8, 2018) if they ride to a location within the Stanford Research Park on an scooter (e.g., scooter 104) during a weekday between the hours of 7:00 AM and 10:00 AM and stay there for 4 hours. This is how one would configure a commuter reward for users who commutes to the Stanford Research Park. However, the users may only receive this award if the users stayed off the sidewalk and had a rider score greater than 90 indicating that they operated the scooter in a safe manner.

In one embodiment, the user 102 may have a user device 106 (e.g., mobile devices, tablets, laptops, and the like). In one embodiment, a user device 106 (or more generally a “user device” or “user computing device” as used variously herein) may refer to a computing device that is associated with a user. In some embodiments, the user computing device can be used to communicate with another device, computer, or system. In particular, the user device 106 can include a user computing device that is used to conduct a transaction. The user computing device may be capable of conducting communications over a network. A user computing device 106 may be in any suitable form. For example, suitable user computing devices can be hand-held and compact so that it can fit into a user's wallet and/or pocket (e.g., pocket-sized). The user computing device 106 can include a processor, and memory, input devices, and output devices, operatively coupled to the processor. Specific examples of user computing devices include cellular or mobile phones, tablet computers, desktop computers personal digital assistants (PDAs), pagers, portable computers, smart cards, and the like. Additional user computing devices may include wearable devices, such as smart watches, glasses fitness bands, ankle bracelets, rings, earrings, etc. In some embodiments, the user computing device may include automobiles with remote communication capabilities.

Environmental context 100 further includes another user 112. In another aspect, the user 112 may also ride a scooter 114 on the sidewalk 111. In one aspect, the user 112 may have a device 116. In such an example, the user 112 may be using the scooter 114 in an unsafe manner (e.g., riding on the sidewalk 111), and the user device 116 may therefore register such unsafe behavior and take an appropriate action, as discussed above. Environmental context 100 also shows a user 132 carrying a device 136, and walking on the sidewalk 111, and not riding a vehicle of any type.

Moreover, environmental context 100 shows another user 122 riding a bicycle 124 on the street 113. In one aspect, the user 122 may have a device (not shown). In another aspect, the user 122 riding the bicycle 124 may also have a similar application running on the user device that the user 102 had (e.g., via user device 106). In particular, the user 122 device may be configured to run such an application to determine that the user 122 is riding the bicycle 124 as opposed to a scooter (e.g., scooter 104). In this manner, the user 122 device and corresponding application may be configured to discriminate between different transportation modes (e.g., scooter, bicycle, and the like). Similar considerations (e.g., driver safety scores, rewards, payments, etc.) as described in connection with the scooter 104 above may apply to the bicycle 124, or any suitable type of transportation vehicle.

Further, the user 122 may obtain the bicycle 124 using a bicycle-sharing program. Similar to the scooter-sharing programs, bicycle-sharing system, public bicycle system, or bike-share scheme, may refer to services in which bicycles (e.g., similar to bicycle 124) are made available for shared use to individuals on a short term basis for a price or free. Many bike share systems allow users (e.g., user 122) to borrow a bike from a dock and return it at another dock belonging to the same system. Docks may refer to bike racks that lock the bike, and only release it by computer control. In one aspect, the user may enter payment information via a user profile on the user device, and the user device may be configured to communicate wirelessly with a docking computer to automatically unlock a bike. The user may return the bike by placing it in the dock, which locks it in place. Other systems may be dockless. In some aspects, the application on the user (e.g., user 122) device may be configured to show nearby available bikes and may open a given dock. Users (similar to user 122) that are registered with the application on the user device may identify themselves with a smart card via the user device at any of the hubs to check out a bicycle for a period of time.

Further, a user (e.g., 102) riding on a scooter (e.g., scooter 104) may have a velocity profile similar to a bicycle (e.g., bicycle 124); moreover, some of the measured accelerations associated with the scooter may also be similar to a bicycle. For example, a scooter rider leans to one side create centripetal force in order to turn, similar to the bicycle rider. However, because the user of a scooter may not need to pedal like a bicycler might, the body movements of a scooter rider may be less than a bicycle rider. Moreover, the longitudinal accelerations of a scooter may be faster than a bicycle; therefore, embodiments of the disclosure are able, via one or more machine learning algorithms (to be described below) running on corresponding user devices, to identify data signatures associated with the riding of a given user on a given vehicle, and thereby associate such data signatures with a unique transportation mode.

Moreover, because the certain environmental contexts 100 (e.g., paving of sidewalks such as sidewalk 111) may be different than other portions of the same or similar environmental contexts 100 (e.g., streets 113), the data associated with the driving of the different vehicles may be different for the users in each portion of the environment. For example, a user (e.g., a user 102) may have a vertical acceleration as the user rides up and down on a sidewalk 111 on a street 113; accordingly, embodiments of the disclosure are able to use such data signatures to distinguish between whether a given vehicle (e.g., a scooter) is being ridden on the street 113 or the sidewalk 111. For example, embodiments of the disclosure may use a convolutional neural network (CNN) that can be trained to classify the data associated with sensors of the user's device (e.g., device 106) to classify the riding data as belonging to the class of a “eScooter Sidewalk” or a class of “eScooter Street.” In various aspects, CNNs may refer to a class of deep, feed-forward artificial neural networks. Further, CNNs may use a variation of multilayer perceptrons designed to require minimal preprocessing.

Moreover, as noted, the user's device (e.g., 106, 116, etc.) may be configured to run an application be used to determine if the user (e.g., user 102 or 122) is riding a scooter (e.g., scooter 104) and may further determine aspects of the user's driving, such as, whether the users are driving on the sidewalk, driving poorly, and the like. Further, the application may be used to determine a riding score associated with the user, which may then be used by various entities (not shown) to either reward or punish users based on acceptable driving behavior.

In some aspects, a riding behavior score may be determined as a function of various variables related to the driving behavior of a user (e.g., user 102 and/or user 122). For example, such variables may include, but not be limited to, the speed and the presence of aggressive acceleration, braking, and cornering. In another aspect, riding on the sidewalk 111 may lower the riding score, and such behavior may be have a particularly high relative effect on the score.

In another aspect, the environmental context 100 may include one or more satellites 130 and one or more cellular towers 133. In another embodiment, the scooter 104, the user device (e.g., user device 106, 116, and/or 136, or the like), and/or the bicycle 124 may include a transceiver, which may in turn may include one or more location receivers (e.g., GPS receivers) that may receive location signals (e.g., GPS signals) from one or more satellites 130. In another embodiment, a GPS receiver may refer to a device that can receive information from GPS satellites (e.g., satellites 130) and calculate the geographical position of one or more of the scooter 104, the user device (e.g., user device 106, 116, and/or 136, or the like), and/or the bicycle 124, using suitable software.

As discussed, the user devices (e.g., user device 106 and/or 116) may be configured to run one or more AI-based algorithms, for example, to score the riding behavior of a corresponding user. Such artificial intelligence (AI) to facilitate automating one or more features described herein. The components can employ various AI-based schemes for carrying out various embodiments and/or examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources (e.g., different sensor inputs). Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

FIG. 1B shows a diagram of a user device in accordance with example embodiments of the disclosure. In particular, the diagram shows a user device 150. In another aspect, the user device 150 may be configured to run an application, which may be able to illustrate various measurements such as a plot 152 of Fourier coefficients of acceleration data determined by using one or more sensor measurements of the user device 150, or by using a plot 152 of Fourier coefficients of position data determined by using one or more sensor measurements of the user device 150.

The user device 150 may use one or more inertial measurement devices (not shown) to determine the device's position. The user device 150 may use dead reckoning and other approaches for positioning of the user device 150 using an inertial measurement unit carried by the user device 150, sometimes referring to maps or other additional sensors to constrain the inherent sensor drift encountered with inertial navigation. In one embodiment, one or more microelectromechanical systems (MEMS) based inertial sensors may be used in the inertial measurement unit of the user device 150 however, the MEMS sensors may be effected by internal noises which may result in cubically growing position error with time. In one embodiment, to reduce the error growth in such devices, a Kalman filtering based approach may be used, by implementing software algorithms on software modules associated with the various sensors in the user device 150.

In another embodiment, the user device 150 may include a transceiver, which may in turn may include one or more location receivers (e.g., GPS receivers) that may receive location signals (e.g., GPS signals) from one or more satellites (not shown). In another embodiment, a GPS receiver may refer to a device that can receive information from GPS satellites (e.g., satellites 130) and calculate the user device's 150 geographical position. Using suitable software, the vehicle may display the position on a map displayed on the user device 150, and the GPS receiver may offer information corresponding to navigational directions.

In another embodiment, the user device 150 may use GPS signals received from a global navigation satellite system (GNSS). In another embodiment, the device 106 may use assisted GPS (A-GPS) technology, which can use base station or cell towers (not shown) to provide a faster time to first fix (TTFF), for example, when GPS signals are poor or unavailable.

In various embodiments, the GPS receiver may be configured to use an L5 frequency band (e.g., centered at approximately 1176.45 MHz) for higher accuracy location determination (e.g., to pinpoint the scooter 104 to approximately one foot accuracy). In another embodiment, the location device may include the capability to detect location signals from one or more non-GPS based systems, for example, to increase the location accuracy determination.

In another embodiment, the wireless signal may be sent to the user device 150. A user device 150 may be configured to communicate with the one or more devices of the scooter 104 using one or more communications networks, wirelessly or wired. Any of the communications networks may include, but not limited to, any one of a combination of different types of suitable communications networks such as, for example, broadcasting networks, public networks (for example, the Internet), private networks, wireless networks, cellular networks, or any other suitable private and/or public networks. Further, any of the communications networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The user device 150 may include one or more communications antennae. Communications antenna may be any suitable type of antenna corresponding to the communications protocols used by the user device 150 and the devices of the scooter 104. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user device.

The user device 150 may include any suitable radio and/or transceiver for transmitting and/or receiving radio frequency (RF) signals in the bandwidth and/or channels corresponding to the communications protocols utilized by any of the user device 150 and/or the scooter's 104 devices to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband

Typically, when a device of the scooter 104 establishes communication with a user device 106 corresponding to user device 150, the device of the scooter 104 may communicate in the downlink direction by sending data frames (e.g. a data frame which can comprise various fields such as a frame control field, a duration field, an address field, a data field, and a checksum field). The data frames may be preceded by one or more preambles that may be part of one or more headers. These preambles may be used to allow the user device 150 to detect a new incoming data frame from the scooter 104 device. A preamble may be a signal used in network communications to synchronize transmission timing between two or more devices (e.g., between the scooter 104 device and user device 150).

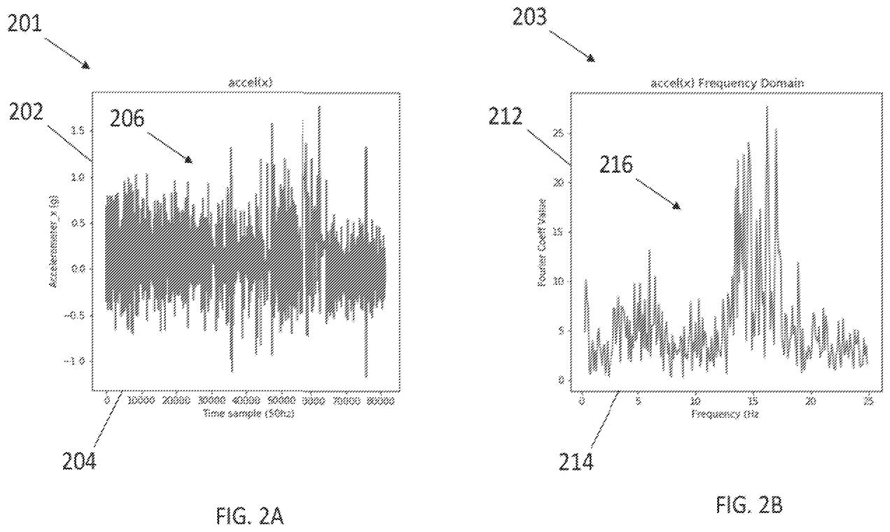

In various aspects, the user devices (e.g., user device 106, 116, and/or 136) may run applications that may further be configured to perform a variety of tasks, in accordance with example embodiments of the disclosure. In particular, the applications may be configured to reduce costs for renting a scooter (e.g., scooter 104) based on a good driving score, which may be determined by analyzing the sensor data associated with the users device as described herein, for example, in connection with FIG. 2. In one aspect, such an application may be configured to automatically pay for ride (e.g., reduced cost ride) using the one or more AI algorithms.

In another aspect, the application running the one or more AI algorithms on or in connection with a user device 150 may be used to determine a riding behavior. For example, the riding behavior may include examples of poor riding which may be logged and may be used in determining a reduced riding score associated with a given user. Examples of poor riding behavior that may be detected using the AI-based algorithms on the data include, but not be limited to, following improperly and/or tailgating; improper or erratic lane changing; illegally riding on a road shoulder, in a ditch, or on a sidewalk or median; passing where prohibited; operating the vehicle in an erratic, reckless, careless, or negligent manner or suddenly changing speeds without changing lanes; failure to yield right of way; failure to obey traffic signs, traffic control devices, or traffic officers, failure to observe safety zone traffic laws; failure to observe warnings or instructions on vehicle displaying them; failure to signal; riding too fast for conditions; racing; making an improper turn; texting while riding, or otherwise using a mobile device illegally; and/or riding under the influence; one or more of the above, and the like.

Other examples of poor riding behavior may include any of the following: nudging pedestrians, which may involve drivers coaxing pedestrians who are trying to cross a crosswalk by honking or crowding them; elongated and/or excessive honking, for instance, honking at a vehicle that is already signaling to make a turn, or at a vehicle with the hazards blinking. Honking when there are other vehicles in front of the vehicle in front of a given driver, or at a red light. Tailgating, which may involve riding dangerously close to the vehicle ahead (often in an attempt to encourage them to increase their speed). Such an action can distract the operator of the forward vehicle and may reduce the stopping time of the rear vehicle in case of sudden speed changes. Changing lanes and turning without use of signals, which may increase the likelihood of an accident by surprising other riders with a lane change or an unexpected turn. Cutting off other motorists, which may refer to a situation where a vehicle that enters a lane without proper caution, leaving a small amount of distance between other surrounding vehicles. Riding below the speed of traffic in center or passing lanes, which may cause a disruption in traffic flow as other vehicles may either slow to match the offending vehicle's speed, and may be forced to pass on the wrong side. Slowly passing another vehicle rather than accelerating, which may cause a disruption for other vehicles in the passing lane for the duration of the time the passing vehicle occupies it. Distracted riding (includes talking on the phone, smoking, drinking, and eating), which may reduce rider awareness of the road and may increase the likelihood of a collision. In one aspect, the score associated with the riding quality of the driver may be reduced by the rider riding the vehicle night.

In another aspect, the riding behavior may include examples of good riding behavior which may be logged and may be used in determining an increased riding score associated with a given user. Examples of good riding behavior that may be detected using the AI-based algorithms on the data include, but not be limited to, maintaining a safe following distance to other vehicles, riding safely considering (adjusting for) weather and/or road conditions, adjusting speed before entering a bend, in order to avoid applying the brakes in the middle of a bend. Further, aspects of good riding behavior may generally include not performing any of the above mentioned examples of poor riding behavior.

FIG. 2A shows a plot of an example acceleration data, in accordance with example embodiments of the disclosure. In particular, plot 201 includes a y-axis 202 representing a magnitude of the x-component accelerometer data in units of G's (where 1 G is approximately 9.8 m/s²) versus a x-axis 204 representing time samples corresponding to a 50 Hertz sample rate. In another aspect, plot 201 includes a curve 206 that represents the data measurements for the accelerometer data over time as measured by a given sensor of the user device (e.g., a mobile phone). In particular, plot 201 illustrates a curve 206 representing a time-domain signal from one of the accelerometers sampled at 50 Hz may be. Such raw, unprocessed data corresponding to curve 206 may not readily facilitate distinguishing between riders of different types of vehicles (e.g., riders of bicycles and scooters). Accordingly, by performing a Fast Fourier Transform (FFT) on the data, the data may allow for such a classification, as described below.

FIG. 2B shows a plot of an example Fourier transform of the acceleration data shown in FIG. 1, in accordance with example embodiments of the disclosure. In particular, plot 203 includes a y-axis 212 representing a magnitude of the Fourier coefficients corresponding to x-component accelerometer data shown in FIG. 1 versus a x-axis 204 representing frequency in units of Hertz (e.g., a frequency range of approximately 0 Hertz to approximately 25 Hz).

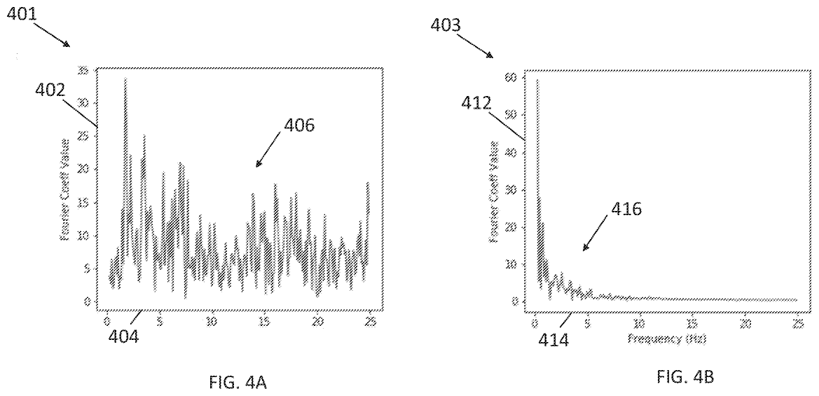

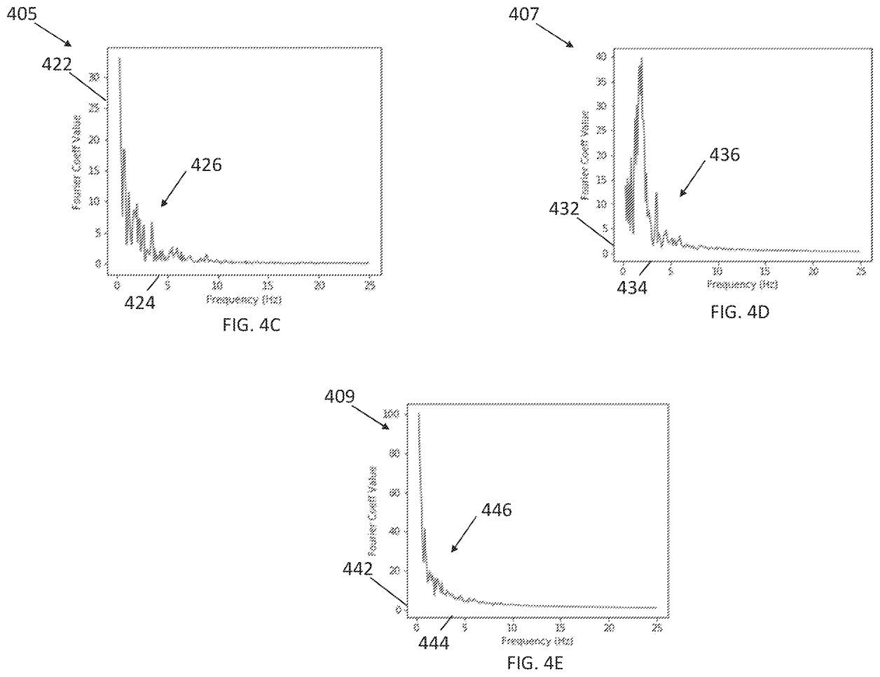

In another aspect, plot 203 includes a curve 216 that represents the Fourier coefficients determined from the curve 206 that represents the accelerometer data measured by a given sensor of the user device (e.g., a mobile phone) over the frequency range. In particular, plot 203 illustrates curve 216 that represents the same accelerometer data of curve 206, shown in the frequency domain after performing a Fourier transform (e.g., a fast Fourier transform, FFT) on the data of curve 206. It may be noted that curve 216 shows a relatively strong harmonic signal in the range of approximately 13 Hz to approximately 17 Hz. This harmonic signal may originate from the electric motor of the scooter, as a similar frequency content is not seen in the same signal coming from a bicycle (to be shown and described in connection with FIG. 4, below). Accordingly, the Fourier analysis performed using data outputted by a user device (e.g., a mobile phone) may be obtained to determine Fourier coefficients (e.g., FFT coefficients) that may be inputted as features to a machine-learning algorithm (e.g., a CNN or similar algorithm) to train the algorithm and later, to use the algorithm to determine if a given rider is riding a certain type of vehicle (e.g., a scooter).

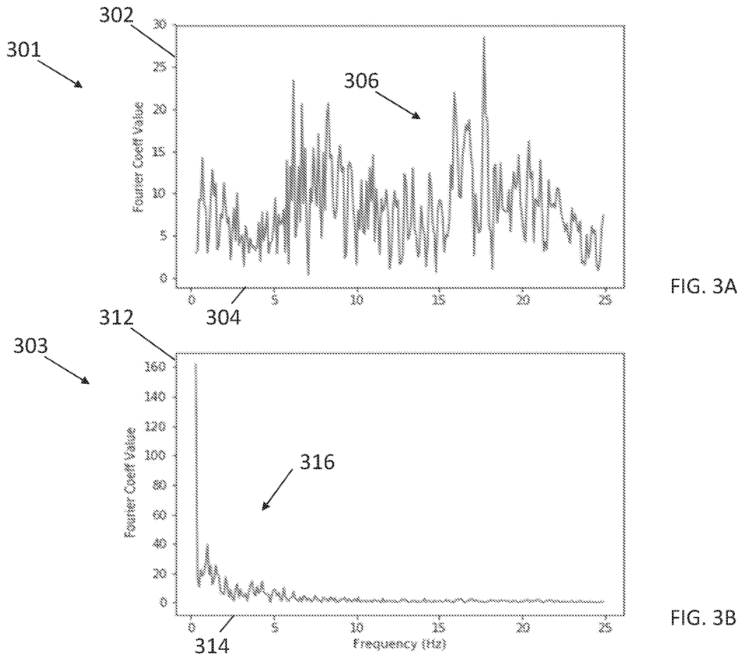

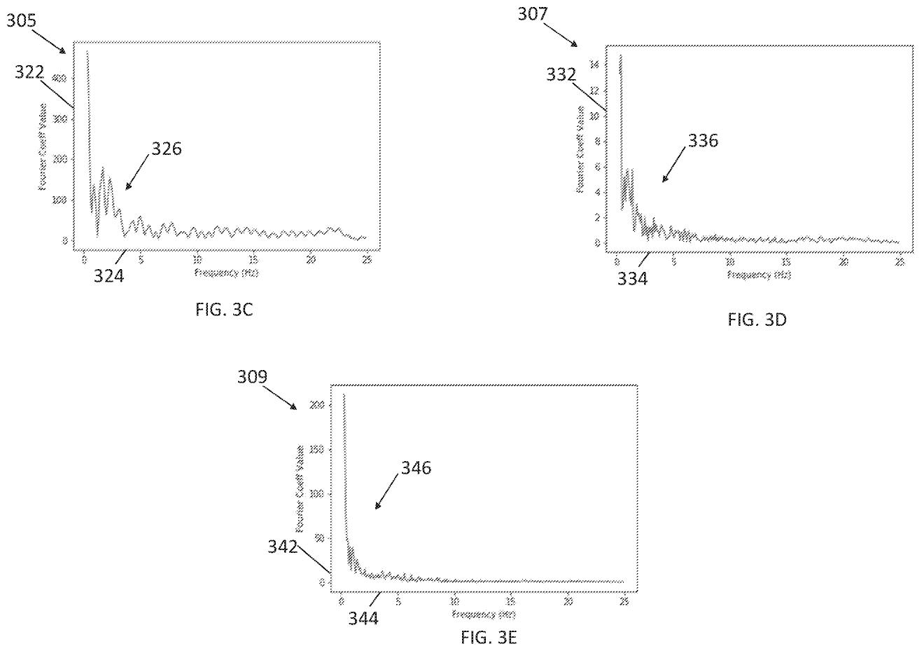

FIG. 3A shows a plot of an example acceleration data for an example scooter operated on a sidewalk, in accordance with example embodiments of the disclosure. In particular, plot 301 includes a y-axis 302 representing a magnitude of the Fourier coefficients corresponding to total accelerometer data versus a x-axis 304 representing frequency in units of Hertz (e.g., a frequency range of approximately 0 Hertz to approximately 25 Hz). In another aspect, plot 301 includes a curve 306 that represents the Fourier coefficients determined from a Fourier transform of data measurements for the accelerometer data as measured by a given sensor of the user device (e.g., a mobile phone).

FIG. 3B shows a plot of an example rotation data, in accordance with example embodiments of the disclosure. In another aspect, plot 303 includes a y-axis 312 that represents a magnitude of the Fourier coefficients corresponding to total rotation data versus a x-axis 314 representing frequency in units of Hertz (e.g., a frequency range of approximately 0 Hertz to approximately 25 Hz). In another aspect, plot 303 includes a curve 316 that represents the Fourier coefficients determined from a Fourier transform of data measurements for the rotation data as measured by a given sensor of the user device (e.g., a mobile phone).

FIG. 3C shows a plot of an example a first component of a total rotation data, in accordance with example embodiments of the disclosure. In another aspect, plot 305 includes a y-axis 322 that represents a magnitude of the Fourier coefficients corresponding to rotation data about an x-axis, and the plot includes an x-axis 324 representing frequency in units of Hertz (e.g., a frequency range of approximately 0 Hertz to approximately 25 Hz). In another aspect, plot 305 includes a curve 326 that represents the Fourier coefficients determined from a Fourier transform of data measurements for the rotation data as measured by a given sensor of the user device (e.g., a mobile phone).

FIG. 3D shows a plot of an example a second component of a total rotation data, in accordance with example embodiments of the disclosure. In one aspect, plot 307 includes a y-axis 332 that represents a magnitude of the Fourier coefficients corresponding to rotation data about an y-axis, and the plot includes an x-axis 334 representing frequency in units of Hertz (e.g., a frequency range of approximately 0 Hertz to approximately 25 Hz). In another aspect, plot 307 includes a curve 336 that represents the Fourier coefficients determined from a Fourier transform of data measurements for the rotation data as measured by a given sensor of the user device (e.g., a mobile phone).

FIG. 3E shows a plot of an example a third component of a total rotation data, in accordance with example embodiments of the disclosure. In another aspect, plot 309 includes a y-axis 342 that represents a magnitude of the Fourier coefficients corresponding to rotation data about a z-axis, and the plot includes an x-axis 344 representing frequency in units of Hertz (e.g., a frequency range of approximately 0 Hertz to approximately 25 Hz). In another aspect, plot 309 includes a curve 346 that represents the Fourier coefficients determined from a Fourier transform of data measurements for the rotation data as measured by a given sensor of the user device (e.g., a mobile phone).

In particular, plots 305, 307, and 309 may be used to determine one or more of the total acceleration of a vehicle (e.g., a scooter). Further plots 305, 307, and 309 represent the individual rotations of the vehicle (e.g., scooter) around each axis (x, y, and z), respectively, versus frequency. The total rotation of the vehicle as shown and described in connection with plot 303, may be calculated as the magnitude of the x, y, and z components of the rotation shown in plots 305, 307, and 309. Accordingly, the total acceleration may be determined as: Atotal=Squareroot(Ax*Ax+Ay*Ay+Az*Az), where Ax, Ay, and Az represent the accelerations on the x, y, and z axes, respectively, as correspond with plots 305, 307, and/or 309, respectively. Further, the plot 301 indicate the pronounced spike at 17 Hz in the curve 306, which may originate from the motor; moreover, the low amount of rotational movement of the user device (e.g., a mobile phone) as determined from plots 305, 307, and 309 correspond well with the fact that the data represents data obtained from a scooter.

FIG. 4A shows a plot of an example acceleration data for an electric bike operating on a road, in accordance with example embodiments of the disclosure. In particular, plot 401 includes a y-axis 402 representing a magnitude of the Fourier coefficients corresponding to total accelerometer data versus a x-axis 404 representing frequency in units of Hertz (e.g., a frequency range of approximately 0 Hertz to approximately 25 Hz).

In another aspect, plot 401 includes a curve 406 that represents the Fourier coefficients determined from a Fourier transform of data measurements for the accelerometer data as measured by a given sensor of the user device (e.g., a mobile phone). FIG. 4B shows a plot of an example rotation data, in accordance with example embodiments of the disclosure.

In another aspect, plot 403 includes a y-axis 412 that represents a magnitude of the Fourier coefficients corresponding to total rotation data versus a x-axis 414 representing frequency in units of Hertz (e.g., a frequency range of approximately 0 Hertz to approximately 25 Hz). In another aspect, plot 403 includes a curve 416 that represents the Fourier coefficients determined from a Fourier transform of data measurements for the rotation data as measured by a given sensor of the user device (e.g., a mobile phone).

FIG. 4C shows a plot of an example a first component of a total rotation data, in accordance with example embodiments of the disclosure. In another aspect, plot 405 includes a y-axis 422 that represents a magnitude of the Fourier coefficients corresponding to rotation data about an x-axis, and the plot includes an x-axis 424 representing frequency in units of Hertz (e.g., a frequency range of approximately 0 Hertz to approximately 25 Hz). In another aspect, plot 405 includes a curve 426 that represents the Fourier coefficients determined from a Fourier transform of data measurements for the rotation data as measured by a given sensor of the user device (e.g., a mobile phone).

FIG. 4D shows a plot of an example a second component of a total rotation data, in accordance with example embodiments of the disclosure. In another aspect, plot 407 includes a y-axis 432 that represents a magnitude of the Fourier coefficients corresponding to rotation data about an y-axis, and the plot includes an x-axis 434 representing frequency in units of Hertz (e.g., a frequency range of approximately 0 Hertz to approximately 25 Hz). In another aspect, plot 407 includes a curve 436 that represents the Fourier coefficients determined from a Fourier transform of data measurements for the rotation data as measured by a given sensor of the user device (e.g., a mobile phone).

FIG. 4E shows a plot of an example a third component of a total rotation data, in accordance with example embodiments of the disclosure. In another aspect, plot 409 includes a y-axis 442 that represents a magnitude of the Fourier coefficients corresponding to rotation data about a z-axis, and the plot includes an x-axis 444 representing frequency in units of Hertz (e.g., a frequency range of approximately 0 Hertz to approximately 25 Hz). In another aspect, plot 409 includes a curve 446 that represents the Fourier coefficients determined from a Fourier transform of data measurements for the rotation data as measured by a given sensor of the user device (e.g., a mobile phone).

In an embodiment, the plots 401, 403, 405, 407, and 409 of FIGS. 4A-4E may be contrasted against the plots 303, 303, 305, 307, and 309 of FIG. 3A-3E. In particular, the plots of FIGS. 4A-4E show data captured on a bicycle. The accelerometer data of plot 401 indicates a relatively strong frequency component at about 2 Hz, which may originate from the pedaling movement of the user. Moreover, a similar motion may be observed in the y-rotation graph corresponding to plot 407 at the same frequency of about 2 Hz. Accordingly, the plots of FIG. 4A-4E and the plots of FIG. 3A-3E indicate that the sensor data may be used to visually distinguish between data coming from a bicycle as opposed to scooter. Accordingly, a CNN may be used to classify signals into different classes, and may be used even if the signals cannot be visually distinguished.

In various embodiments, analyzing a large quantity of similar data may be used to confirm that various movements associated with a given transportation type (e.g., pedaling for bicycles) can be determined from such data. Further, the lack of significant rotational movement on the scooter as well as the frequency contribution of the motor may also be similarly detectable, as shown and described in connection with FIGS. 3A-3E, above. Accordingly, the built-in transportation mode functionality (e.g., sensor data) in a user device (e.g., a mobile phone) may be used to detect if a user is riding a particular type of vehicle, for example, either cycling or taking a scooter. Further an AI-based algorithm such as CNN may be used along with accelerometer and/or gyroscope data to determine whether the user is on a given vehicle.

As noted, if users are engaging in certain behaviors (e.g., if the users are riding on an scooter and on designated portions of an environment in a safe manner), one or more smart contracts running on a blockchain platform may be used to provide instance remittance of rewards (or penalties if said users are engaging in detrimental behaviors), for example, using cryptocurrencies or company-based tokens.

In some aspects, the users of the vehicles such as scooters may download a related application on their user device (e.g., a mobile phone). In another aspect, the application may be configured to provide the users with potential rewards (e.g., monetary rewards, for example, in the form of cryptocurrency, and/or other promotional awards). Further, the users may, in some embodiments, be required to download such applications on their devices before being allowed to sign up with an scooter service.

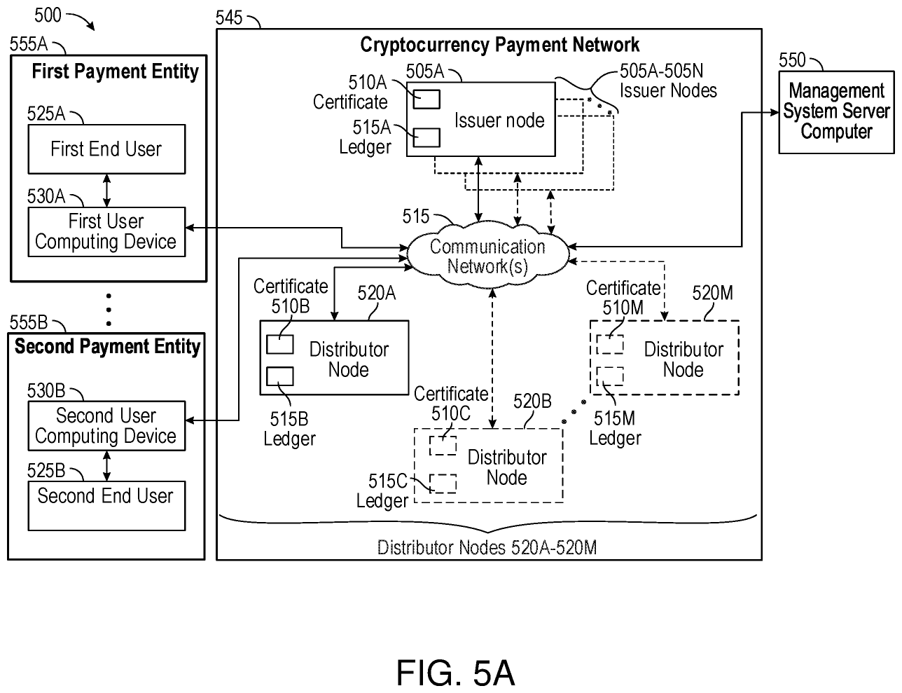

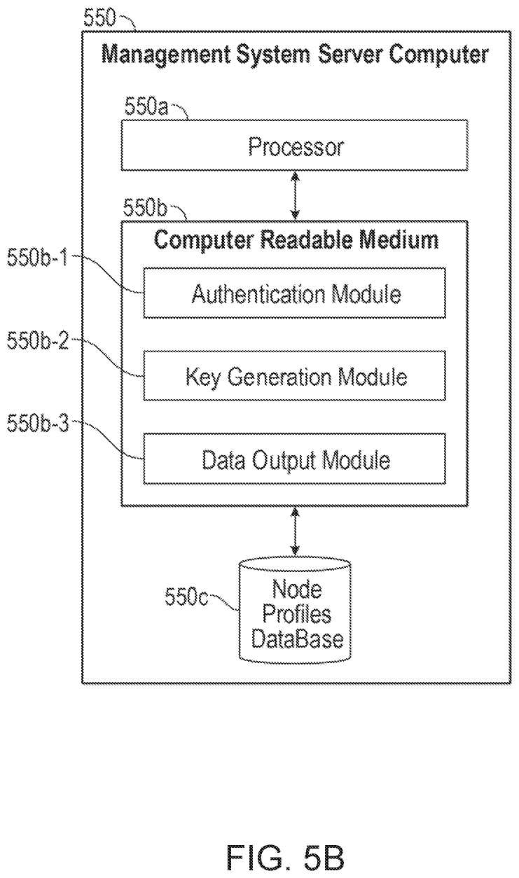

In another aspect, FIG. 5 shows a block diagram of an exemplary system including a cryptocurrency payment network that may be used for the implementation of such rewards, in accordance with example embodiments of the disclosure. S system 500 in FIG. 5 includes a cryptocurrency payment network 545 that may be connected to a peer-to-peer network that may include a first payment entity 555A comprising a first end user 525A with a first user computing device 530A, a second payment entity 555B comprising a second end user 525B with a second user computing device 530B, one or more issuer nodes 505A-505N, one or more distributor nodes 520A-520M, and a management system server computer 550. In some embodiments, the first end user 525A and the second end user 525B may be one of an individual user, a business entity, and an organization. Each of these systems and computers may be in operative communication with each other via any suitable communication medium (including the Internet), using any suitable communications protocol.

In the embodiment shown in FIG. 5, the systems and computers are shown to interact via one or more communication networks 515 (e.g., one or more of the Internet, private communication networks, and public communication networks). In some aspects, an example number of components are shown in system 500. It is understood, however, that embodiments of the disclosure may include more than one of each component. In addition, some embodiments of the disclosure may include fewer than or greater than all of the components shown in FIG. 5. In another embodiment, the inclusion of dotted lines indicates optional features that indicate that the number of these entities included in various embodiments may be different. Similarly, the use of “N” and “M” when referring to the issuer nodes 505A-505N and distributor nodes 520A-520M indicates that there may be any number of these entities in various embodiments, and further that there need not be the same number of issuer nodes 505A-505N and distributor nodes 520A-520M in various cryptocurrency payment network 545 configurations. In another embodiment, the user computing devices 530A-530B may be in any suitable form. For example, suitable user computing devices may be hand-held and compact so that they can fit into a user's pocket. Examples of user computing devices 530A-530B may include any device capable of accessing the Internet. Specific examples of user computing devices 530A-530B include cellular or wireless phones (e.g., smartphones), tablet phones, tablet computers, laptop computers, desktop computers, terminal computers, work stations, personal digital assistants (PDAs), physical cryptocurrency wallet hardware, pagers, portable computers, smart cards, and the like. In some embodiments of the disclosure, the user computing devices 530A-530B and a payment device associated with the user may be a single device (e.g., a mobile phone).

The user computing devices 530A-530B may include a processor and a computer readable medium coupled to the processor, the computer readable medium comprising code, executable by the processor for performing the functionality described herein. The user computing devices 530A-530B may transmit data through the communication networks 515 to issuer nodes 505A-505N, distributor nodes 520A-520M, and to the other user computing devices 530A-530B. For example, the first user computing device 530A may represent a client's device be communicatively coupled to the second user computing device 530B via the communication networks 515 to conduct a transaction with a provider (e.g., a service provider) associated with the second user computing device 530B.

In some embodiments, the cryptocurrency payment network 545 may comprise one or more server computers (not illustrated) implementing the issuer nodes 505A-505N and the distributor nodes 520A-520M. In some embodiments, each issuer node 505A-505N and distributor node 520A-520M may be a server computer associated with a separate financial institution. For example, each issuer node 505A-505N may be associated with a central bank, federal reserve, or government authority, while each distributor node 520A-520M may be associated with a different commercial bank. In various embodiments, each issuer node and/or distributor node may be implemented by a separate computing device (e.g., server computer). However, in some embodiments, a single server computer may implement multiple issuer nodes and/or distributor nodes. The issuer nodes 505A-505N and the distributor nodes 520A-520M may include a processor and a computer readable medium coupled to the processor, the computer readable medium comprising code, executable by the processor for performing the functionality described herein.

In some embodiments, each of the distributor nodes 520A-520M may be implemented by one or more server computers that maintain user profiles and/or account data (e.g., financial account data) for one or more of the end users 525A-525B. For example, in some embodiments, each of the distributor nodes 520A-520M is hosted by a respective financial institution (e.g., a bank), and thus each distributor node 520A-520M may have an explicit relationship with one or more of the end users 525A-525B through a financial account, where the end user may have provided information to the financial institution (e.g., name, address, phone number, demographic information, government identification data such as a Social Security Number (SSN), etc.).

As noted above, the cryptocurrency payment network 545 may be comprised of issuer nodes 505A-505N and distributor nodes 520A-520M in communications via the communications network 515. In some embodiments, each of these node may be granted the rights and ability to participate in the cryptocurrency payment network 545 by the management system server computer 550. In such embodiments, the management system server computer 550 may be configured to generate and distribute digital certificates, including a node verification public key, to each of the nodes to allow the nodes to function in the cryptocurrency payment network 545. The node verification public key may part of a node verification key pair, which may include a node verification private key. The node verification key pair may be an asymmetric key pair such that the node verification public key may be used to encrypt a message sent from a node to the management system server computer 550, and the corresponding node verification private key for that node may be used by the management system server computer 550 to decrypt the message.

The node verification key pair may be generated by a management system server computer 550 in response to a request message from a node to be designated an issuer node or a distributor node in the cryptocurrency payment network 545. In other embodiments, the node verification key pair may be generated by a node and sent to the management system server computer 550. In some embodiments, node verification public keys may be sent to the issuer nodes 505A-505N and distributor nodes 520A-520M by encrypting each of the node verification public key such that only the associated node can decrypt their node verification public key.

In some embodiments, each of the issuer nodes 505A-505N and each of the distributor nodes 520A-520M may maintain a ledger 515A-515M of the payment transactions made in the cryptocurrency payment network 545. In some embodiments, the ledgers 515A-515M may include a list of transactions with each entry including a sender address, a receiver address, and an amount of digital currency for each transaction. In some embodiments, the ledger may include a record of all transactions ever performed using the digital currency.

In some embodiments, a payment transaction may only be considered official and successfully processed when the payment transaction is recorded in (all or one or more of) the ledgers 515A-515M. Thus, in some embodiments, all payment transaction messages need to be transmitted to the nodes maintaining the ledgers 515A-515M. In some embodiments, a payment entity (e.g., 555A) transmits a payment transaction message to each of the nodes maintaining a ledger, but in other embodiments the payment entity 555A may transit the payment transaction message to just one of these nodes (which in turn forwards it to the other ledger-maintaining nodes) or to another computing device specially configured to provide payment transaction messages to the ledger-maintaining nodes. In some embodiments, only a subset of the nodes may maintain a ledger (e.g., only distributor node 520B) or entirely different entities altogether may maintain the ledger.

The nodes and payment entities within the cryptocurrency payment network 545 may use a digital signature for performing transactions (e.g., transferring digital currency), which is based upon the use of digital certificate. A digital certificate, in embodiments of the disclosure, may utilize a transaction key pair (e.g., a transaction public key and a transaction private key). In some embodiments, each node can use the transaction private key to generate a digital signature (and thus, a payment message), and the node's transaction public key can be made publicly available (e.g., to other nodes in the cryptocurrency payment network 545) to allow other nodes to verify the authenticity of the payment transaction, and correspondingly record the payment transaction in their respective ledgers. In some embodiments, the transaction public key may be a “destination address” identifying a recipient of a digital currency payment.

For example, when a first payment entity 555A wishes to send digital currency to a second payment entity 555B, the first payment entity 555A generates a digital signature by: (1) creating a payment message identifying some digital currency held by the first payment entity 555A and also identifying the recipient the funds (e.g., using a transaction public key of the second payment entity 555B), (2) encrypting the payment message using the transaction private key of the first payment entity 555A, (3) and sending the encrypted payment message to the second payment entity 555B and to the other nodes in the cryptocurrency payment network 545. The other entities (e.g., nodes, payment entities, etc.) in the cryptocurrency payment network 545 may then use the transaction public key of the first payment entity 555A to verify that the amount of digital currency is valid and has been transferred to the second payment entity 555B by the first payment entity 555A. Once the transaction is verified, the transaction may be published into ledgers (e.g., ledger 515A-515M) maintained by the one or more nodes in the cryptocurrency payment network 545.

In some embodiments, an issuer node 505A may be granted a digital certificate (e.g., 510A) by the management system server computer 550. The issuer node 505A can use this digital certificate to initiate the process of generating digital currency. There are a variety of ways to generate additional digital currency, including but not limited to the issuer node 505A creating a new payment transaction to itself, and creating new payment transactions to any of the distributor nodes 520A-520M, etc. In some embodiments, these payment transactions reference completely new currency that has not previously existed until that payment transaction—the issuer nodes 505 are able to generate or invent new digital currency simply by the authority granted to it by the management system server computer 550. Embodiments of the disclosure allow for the use of many different types of digital certificates and cryptographic algorithms known to those of skill in the art, including but not limited to the use of elliptic curve digital signature algorithm (ECDSA), the secure hash algorithm (SHA) family of cryptographic hash functions (e.g., SHA-1 family, SHA-2 family, SHA-3 family, etc.), the Scrypt algorithm, etc.

In some embodiments, a distributor node 520A may also be granted a digital certificate (e.g., 510B) by the management system server computer 550. The distributor node 520A can use this digital certificate, after receiving an amount of digital currency from an issuer node 505A, to distribute an amount of the of the digital currency to one of the payment entities (e.g., 555A, 555B) or to another distributor node (e.g., 520B-520M). For example, the distributor node 520A can create a new payment transaction to the first payment entity 555A by generating a digital signature by: (1) creating a payment message identifying some of the received digital currency held by the distributor node 520A and also identifying the recipient the funds (e.g., using a transaction public key or destination address of the first payment entity 555A), (2) encrypting the payment message using the transaction private key of the distributor node 520A, (3) and sending the encrypted payment message to the first payment entity 555A and to the other nodes in the cryptocurrency payment network 545. Other entities (e.g., nodes, payment entities, etc.) in the cryptocurrency payment network 545 may then use the transaction public key of the first payment entity 555A to verify that the amount digital currency is valid and has been transferred to the second payment entity 555B by the distributor node 520A. Once the transaction is verified, the transaction may be published into ledgers (e.g., ledger 515A-515M) maintained by the one or more nodes in the cryptocurrency payment network 545.

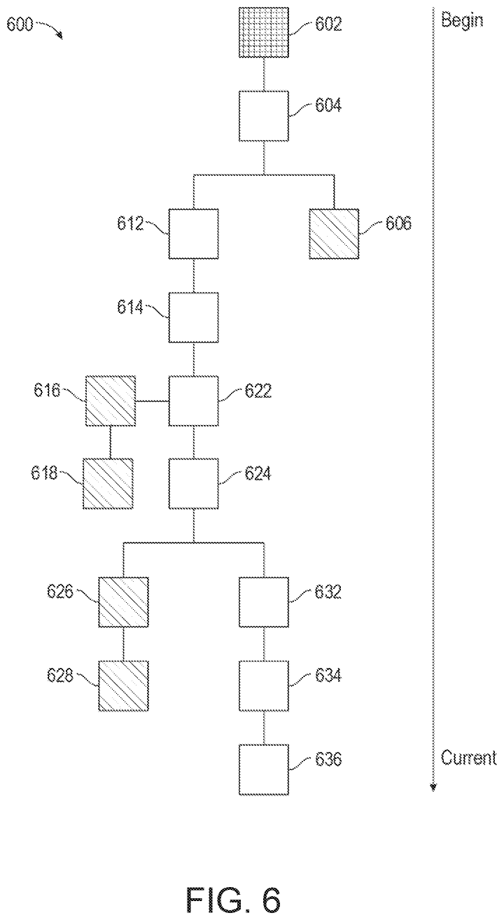

FIG. 6 is a diagram 600 illustrating an example blockchain, in accordance with example embodiments of the disclosure. Further, the blockchain may be used to secure the transmission of rewards to the users, and/or to establish the smart contracts described above. In another aspect, the blockchain may be implemented via a blockchain protocol on a peer-to-peer network. Blocks in the main chain 602, 604, 612, 614, 622, 624, 632, 634, 636 may comprise the longest series of blocks that go from the beginning block 602 to the current block 636. For any block in the blockchain, there may only be one path from the beginning block 602 to the current block 636. Blocks 606, 616, 618, 626, 628 include blocks that are not in the longest chain. In another embodiment, the system may be a distributed system, such that blocks 616, 618, 626, 628 may be created only a few seconds apart from the main chain. In another embodiment, whenever a fork happens, generating computing nodes build onto which ever block is received first in time. Therefore, the short chain of blocks 616, 618, 626, 628 may not be used. In another example, each user of the blockchain in FIG. 6 may be a member. In another embodiment, after a set number of members vote on the addition of a new block in the block chain, may a block chain be added. In this member-based system, the short chains of block 616, 618, 626, 628 may not be created.

In another embodiment, the blockchain may include two kinds of records: transactions and blocks. Transactions may refer to the actual data stored in the blockchain. In another embodiment, the data in each of the blockchain may be encrypted. In one example, the data in each block may represent a single transaction. In another example, data in each block may represent more than on transaction that is dividable into sections within each block, such as, an image in series of images. Transactions are created by users or participants using the system. The blocks are recorded that confirm when and in what sequence certain transaction become journaled as back of the blockchain database.

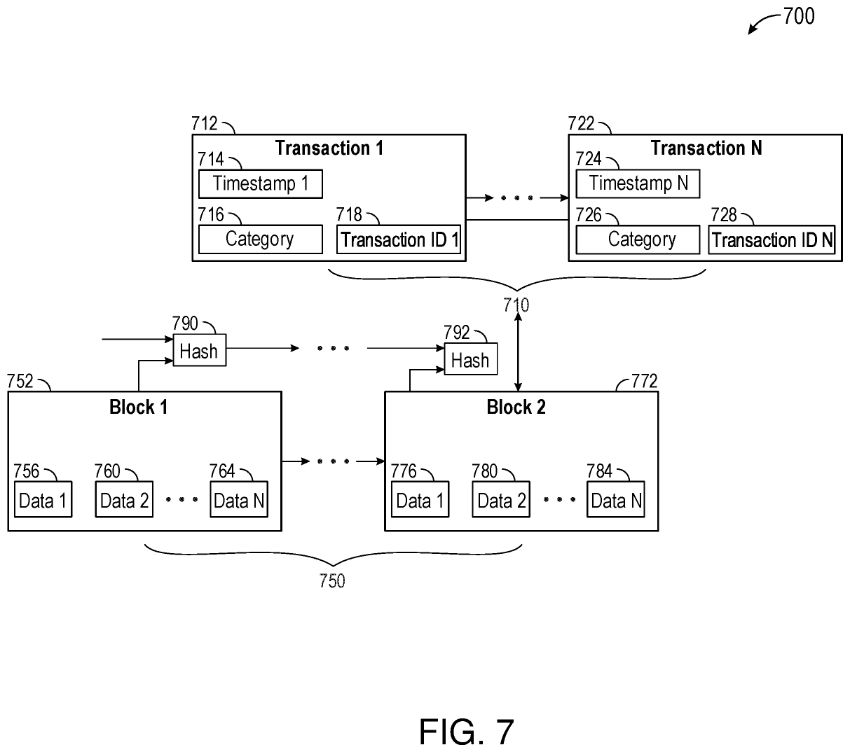

FIG. 7 shows a functional diagram 700 illustrating details of each block and transaction in a blockchain, in accordance with example embodiments of the disclosure. In particular, the diagram 700 shows two kinds of record blocks 710 and transactions 750. The transactions 750 may include data stored in the blockchain. The blocks 710 include records of transactions. In this example transactions may be associated with block 2 772, while other transactions (not shown) may be associated with block 1 752.

In various aspects, record blocks 710 may represent a series of transactions 712 through 712 as shown for transactions 1 through transaction N, respectively. In another embodiment, a given record block 710 may represent a transaction and may include a timestamp (e.g., timestamp 714 or timestamp 724) of the transaction and a unique transaction identifier (e.g., transaction identifier 1 718 and transaction identifier N 728. In one embodiment, the transaction identifier can be search for a specific item in the transactional database management system. Also shown is an optional category for the transaction 716, such as photo, medical, financial, employment, and the like to associate with the additional data in the transactions 750 described below.

In one embodiment, a hash function 790 and 792 is shown as part of the record blocks 710. In one implementation of a blockchain, the previously hash function 790 may be input to a subsequent hash function 792, along with the transaction 1 as shown. This may ensure that there has been no tampering or alteration of the data in the record blockchain. Transactions 750 shown in block 1 through block N, (752, 772) may contain user or additional data 756, 760, 764, 776, 780, 784. The additional data can represent any suitable type of data including text, audio, video, images, financial statements, and more.

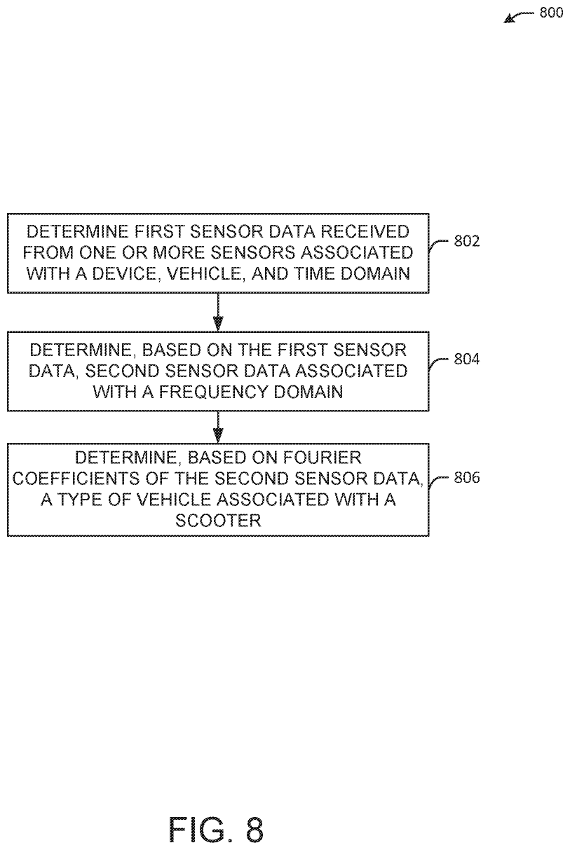

FIG. 8 shows a diagram of an example flow diagram 800, in accordance with example embodiments of the disclosure. At block 802, a first sensor data received from one or more sensors associated with a device may be determined, where the first sensor data is associated with a vehicle and with a time domain. In one embodiment, the first sensor data may include acceleration data associated with the vehicle. Further, the acceleration data may be determined based on an x-component acceleration data, a y-component acceleration data, and a z-component acceleration data.

At block 804, second sensor data associated with a frequency domain may be determined based on the first sensor data, where determining the second sensor data may include performing Fourier transform on the first sensor data to determine Fourier coefficients associated with the first sensor data. Further, a portion of the first sensor data may be determined to serve as first training data, a third sensor data may be determined to serve as second training data, and the machine learning algorithm may be trained using at least one of the first training data or the second training data.

At block 806, a type of the vehicle may be determined based on the Fourier coefficients, using a machine learning algorithm. In one aspect, the machine learning algorithm includes a deep-learning algorithm. the machine learning algorithm includes a convolutional neural network. The type of vehicle may be associated with a scooter.

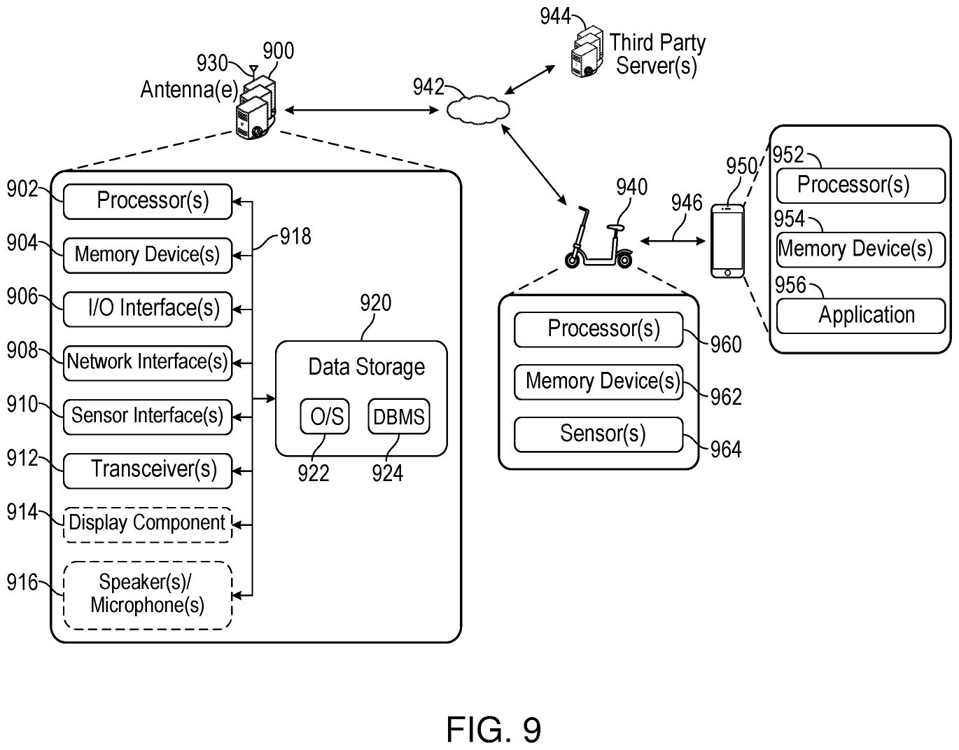

FIG. 9 is a schematic illustration of an example server architecture for one or more server(s) 900 in accordance with one or more embodiments of the disclosure. The server 900 illustrated in the example of FIG. 9 may correspond to a server that may be used by a vehicle (e.g., scooter 104) on a network associated with the vehicle or a user device. In an embodiment, the server 900 may include a cloud-based server that may serve to store and transmit information. Some or all of the individual components may be optional and/or different in various embodiments. In some embodiments, at least one of the servers described FIG. 9 may be located at an autonomous vehicle.

The server 900 may be in communication with a vehicle 940 (e.g., a scooter 104 of FIG. 1), and one or more user devices 950. The vehicle 940 may be in communication with the one or more user devices 950. Further, the server 900, the vehicle 940, and/or the user devices 950 may be configured to communicate via one or more networks 942. The autonomous vehicle 940 may additionally be in wireless communication 944 with the user devices 950 via a connection protocol such as Bluetooth or Near Field Communication. Such network(s) 942 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server 900 may include one or more processors (processor(s)) 902, one or more memory devices 904 (also referred to herein as memory 904), one or more input/output (I/O) interface(s) 906, one or more network interface(s) 908, one or more sensor(s) or sensor interface(s) 910, one or more transceiver(s) 912, one or more optional display components 914, one or more optional camera(s)/microphone(s) 916, and data storage 920. The server 900 may further include one or more bus(es) 918 that functionally couple various components of the server 900. The server 900 may further include one or more antenna(e) 930 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 918 may include at least one of a system bus, a memory bus, an address bus, or a message bus, and may permit the exchange of information (e.g., data (including computer-executable code), signaling, etc.) between various components of the server 900. The bus(es) 918 may include, without limitation, a memory bus or a memory controller, a peripheral bus, an accelerated graphics port, and so forth. The bus(es) 918 may be associated with any suitable bus architecture.

The memory 904 of the server 900 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

The data storage 920 may include removable storage and/or non-removable storage including, but not limited to, magnetic storage, optical disk storage, and/or tape storage. The data storage 920 may provide non-volatile storage of computer-executable instructions and other data.

The data storage 920 may store computer-executable code, instructions, or the like that may be loadable into the memory 904 and executable by the processor(s) 902 to cause the processor(s) 902 to perform or initiate various operations. The data storage 920 may additionally store data that may be copied to the memory 904 for use by the processor(s) 902 during the execution of the computer-executable instructions. More specifically, the data storage 920 may store one or more operating systems (O/S) 922; one or more database management systems (DBMS) 924; and one or more program module(s), applications, engines, computer-executable code, scripts, or the like. Some or all of these component(s) may be sub-component(s). Any of the components depicted as being stored in the data storage 920 may include any combination of software, firmware, and/or hardware. The software and/or firmware may include computer-executable code, instructions, or the like that may be loaded into the memory 904 for execution by one or more of the processor(s) 902. Any of the components depicted as being stored in the data storage 920 may support functionality described in reference to corresponding components named earlier in this disclosure.

The processor(s) 902 may be configured to access the memory 904 and execute the computer-executable instructions loaded therein. For example, the processor(s) 902 may be configured to execute the computer-executable instructions of the various program module(s), applications, engines, or the like of the server 900 to cause or facilitate various operations to be performed in accordance with one or more embodiments of the disclosure. The processor(s) 902 may include any suitable processing unit capable of accepting data as input, processing the input data in accordance with stored computer-executable instructions, and generating output data. The processor(s) 902 may include any type of suitable processing unit.

Referring now to other illustrative components depicted as being stored in the data storage 920, the O/S 922 may be loaded from the data storage 920 into the memory 904 and may provide an interface between other application software executing on the server 900 and the hardware resources of the server 900.

The DBMS 924 may be loaded into the memory 904 and may support functionality for accessing, retrieving, storing, and/or manipulating data stored in the memory 904 and/or data stored in the data storage 920. The DBMS 924 may use any of a variety of database models (e.g., relational model, object model, etc.) and may support any of a variety of query languages.

Referring now to other illustrative components of the server 900, the input/output (I/O) interface(s) 906 may facilitate the receipt of input information by the server 900 from one or more I/O devices as well as the output of information from the server 900 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. The I/O interface(s) 906 may also include a connection to one or more of the antenna(e) 930 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The server 900 may further include one or more network interface(s) 908 via which the server 900 may communicate with any of a variety of other systems, platforms, networks, devices, and so forth. The network interface(s) 908 may enable communication, for example, with one or more wireless routers, one or more host servers, one or more web servers, and the like via one or more networks.

The sensor(s)/sensor interface(s) 910 may include or may be capable of interfacing with any suitable type of sensing device such as, for example, inertial sensors, force sensors, thermal sensors, photocells, and so forth.

The display component(s) 914 may include one or more display layers, such as LED or LCD layers, touch screen layers, protective layers, and/or other layers. The optional camera(s) 916 may be any device configured to capture ambient light or images. The optional microphone(s) 916 may be any device configured to receive analog sound input or voice data. The microphone(s) 916 may include microphones used to capture sound.

It should be appreciated that the program module(s), applications, computer-executable instructions, code, or the like depicted in FIG. 9 as being stored in the data storage 920 are merely illustrative and not exhaustive and that processing described as being supported by any particular module may alternatively be distributed across multiple module(s) or performed by a different module.

It should further be appreciated that the server 900 may include alternate and/or additional hardware, software, or firmware components beyond those described or depicted without departing from the scope of the disclosure.

The user device 950 may include one or more computer processor(s) 952, one or more memory devices 954, and one or more applications, such as a application 956. Other embodiments may include different components.

The processor(s) 952 may be configured to access the memory 954 and execute the computer-executable instructions loaded therein. For example, the processor(s) 952 may be configured to execute the computer-executable instructions of the various program module(s), applications, engines, or the like of the device to cause or facilitate various operations to be performed in accordance with one or more embodiments of the disclosure. The processor(s) 952 may include any suitable processing unit capable of accepting data as input, processing the input data in accordance with stored computer-executable instructions, and generating output data. The processor(s) 952 may include any type of suitable processing unit.

The memory 954 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the user device 950, the application 956 may be a mobile application executable by the processor 952 that can be used to present options and/or receive user inputs of information related to the disclosed embodiments. In addition, the user device 950 may communicate with the vehicle 940 via the network 942 and/or a direct connect, which may be a wireless or wired connection. The user device 950 may include a camera, scanner, bio reader or the like to capture biometric data of a user, perform certain processing step on the biometric date, such as extracting features from captures biometric data, and then communicated those extracted features to one or more remote servers, such as one or more of cloud-based servers.

It should be appreciated that the program module(s), applications, computer-executable instructions, code, or the like depicted in FIG. 9 as being stored in the data storage 920 are merely illustrative and not exhaustive and that processing described as being supported by any particular module may alternatively be distributed across multiple module(s) or performed by a different module.

It should further be appreciated that the server 900 may include alternate and/or additional hardware, software, or firmware components beyond those described or depicted without departing from the scope of the disclosure.

The operations described and depicted in the illustrative methods and process flows of FIGS. 1-9 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-9 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Example embodiments of the disclosure may include one or more of the following examples:

Example 1 may include a device, comprising: at least one memory that stores computer-executable instructions; and at least one processor of the one or more processors configured to access the at least one memory, wherein the at least one processor of the one or more processors is configured to execute the computer-executable instructions to: determine first sensor data received from one or more sensors associated with the device, wherein the first sensor data is associated with a vehicle and with a time domain; determine, based on the first sensor data, second sensor data associated with a frequency domain, wherein to determine the second sensor data comprises to perform a Fourier transform on the first sensor data to determine Fourier coefficients associated with the first sensor data; and determine, based on the Fourier coefficients, using a machine learning algorithm, a type of the vehicle, wherein the type of the vehicle is associated with a scooter.

Example 2 may include the device of example 1, wherein the first sensor data comprises an acceleration data.

Example 3 may include the device of example 2 and/or some other example herein, wherein the at least one processor is further configured to execute the computer-executable instructions to determine the acceleration data based on an x-component acceleration data, a y-component acceleration data, and a z-component acceleration data.

Example 4 may include the device of example 1 and/or some other example herein, wherein the at least one processor is further configured to execute the computer-executable instructions to determine third sensor data from the device, wherein the third sensor data comprises rotation data.

Example 5 may include the device of example 4 and/or some other example herein, wherein the at least one processor is further configured to execute the computer-executable instructions to determine the rotation data based on an x-component rotation data, a y-component rotation data, and a z-component rotation data.

Example 6 may include the device of example 1 and/or some other example herein, wherein the machine learning algorithm includes a deep-learning algorithm.

Example 7 may include the device of example 1 and/or some other example herein, wherein the machine learning algorithm includes a convolutional neural network.

Example 8 may include the device of example 1 and/or some other example herein, wherein the at least one processor is further configured to execute the computer-executable instructions to: determine a portion of the first sensor data to serve as first training data; determine third sensor data to serve as second training data; and train the machine learning algorithm using at least one of the first training data or the second training data.

Example 9 may include a method, comprising: determining training data, the training data comprising first data associated with a first vehicle and second data associated with a second vehicle; determine first sensor data received from a first device, wherein the first sensor data is associated with the first vehicle and with a time domain; determine second sensor data received from a second device, wherein the second sensor data is associated with the second vehicle and with the time domain; determine, based on the first sensor data, third sensor data associated with a frequency domain, wherein to determine the third sensor data comprises to perform a Fourier transform on the first sensor data to determine first Fourier coefficients associated with the first sensor data; determine, based on the second sensor data, fourth sensor data associated with the frequency domain, wherein to determine the fourth sensor data comprises to perform a Fourier transform on the second sensor data to determine second Fourier coefficients associated with the second sensor data; determine, based on the first Fourier coefficients and the training data, using a machine learning algorithm, a type of the first vehicle, wherein the type of the first vehicle is associated with a scooter; and determine, based on the second Fourier coefficients and the training data, using the machine learning algorithm, a type of the second vehicle, wherein the type of the second vehicle is different than the type of the first vehicle.

Example 10 may include the method of example 9, wherein the first data comprises labeled data and third Fourier coefficients, and the second data comprises labeled data and includes fourth Fourier coefficients.

Example 11 may include the method of example 9 and/or some other example herein, wherein the first sensor data comprises acceleration data associated with the first vehicle.

Example 12 may include the method of example 11 and/or some other example herein, wherein the method further comprises determining the acceleration data based on an x-component acceleration data, a y-component acceleration data, and a z-component acceleration data.

Example 13 may include the method of example 9 and/or some other example herein, wherein the method further comprises determining third sensor data, wherein the third sensor data comprises a rotation data.

Example 14 may include the method of example 13 and/or some other example herein, wherein the method further comprises determining the rotation data based on an x-component rotation data, a y-component rotation data, and a z-component rotation data.

Example 15 may include the method of example 9 and/or some other example herein, wherein the machine learning algorithm includes a deep-learning algorithm.

Example 16 may include the method of example 9 and/or some other example herein—wherein the machine learning algorithm includes a convolutional neural network.

Example 17 may include a method, comprising: determining, by at least one processor of a device, first sensor data received from one or more sensors associated with the device, wherein the first sensor data is associated with a vehicle and with a time domain; determining, by the at least one processor, based on the first sensor data, second sensor data associated with a frequency domain, wherein to determine the second sensor data comprises to perform a Fourier transform on the first sensor data to determine Fourier coefficients associated with the first sensor data; and determining, by the at least one processor, based on the Fourier coefficients, using a machine learning algorithm, a type of the vehicle, wherein the type of the vehicle is associated with a scooter.

Example 18 may include the method of example 17, wherein the first sensor data comprises acceleration data associated with the vehicle, and the method further comprises determining the acceleration data based on an x-component acceleration data, a y-component acceleration data, and a z-component acceleration data.

Example 19 may include the method of example 17 and/or some other example herein, wherein the method further comprises determining third sensor data, wherein the third sensor data comprises a rotation data.

Example 20 may in include the method of example 17 and/or some other example herein, further comprising: determining a portion of the first sensor data to serve as first training data; determining third sensor data to serve as second training data; and training the machine learning algorithm using at least one of the first training data or the second training data.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. A device, comprising:
at least one memory that stores computer-executable instructions; and
at least one processor of the one or more processors configured to access the at least one memory, wherein the at least one processor of the one or more processors is configured to execute the computer-executable instructions to:
determine first sensor data received from one or more sensors associated with the device, wherein the first sensor data is associated with a vehicle and with a time domain;
determine, based on the first sensor data, second sensor data associated with a frequency domain, wherein to determine the second sensor data comprises to perform a Fourier transform on the first sensor data to determine Fourier coefficients associated with the first sensor data; and
determine, based on the Fourier coefficients, using a machine learning algorithm, a type of the vehicle, wherein the type of the vehicle is associated with a scooter.

2. The device of claim 1, wherein the first sensor data comprises an acceleration data.

3. The device of claim 2, wherein the at least one processor is further configured to execute the computer-executable instructions to determine the acceleration data based on an x-component acceleration data, a y-component acceleration data, and a z-component acceleration data.

4. The device of claim 1, wherein the at least one processor is further configured to execute the computer-executable instructions to determine third sensor data from the device, wherein the third sensor data comprises rotation data.

5. The device of claim 4, wherein the at least one processor is further configured to execute the computer-executable instructions to determine the rotation data based on an x-component rotation data, a y-component rotation data, and a z-component rotation data.

6. The device of claim 1, wherein the machine learning algorithm includes a deep-learning algorithm.

7. The device of claim 1, wherein the machine learning algorithm includes a convolutional neural network.

8. The device of claim 1, wherein the at least one processor is further configured to execute the computer-executable instructions to:
determine a portion of the first sensor data to serve as first training data;
determine third sensor data to serve as second training data; and
train the machine learning algorithm using at least one of the first training data or the second training data.

9. A method, comprising:
determining training data, the training data comprising first data associated with a first vehicle and second data associated with a second vehicle;
determine first sensor data received from a first device, wherein the first sensor data is associated with the first vehicle and with a time domain;
determine second sensor data received from a second device, wherein the second sensor data is associated with the second vehicle and with the time domain;
determine, based on the first sensor data, third sensor data associated with a frequency domain, wherein to determine the third sensor data comprises to perform a Fourier transform on the first sensor data to determine first Fourier coefficients associated with the first sensor data;
determine, based on the second sensor data, fourth sensor data associated with the frequency domain, wherein to determine the fourth sensor data comprises to perform a Fourier transform on the second sensor data to determine second Fourier coefficients associated with the second sensor data;
determine, based on the first Fourier coefficients and the training data, using a machine learning algorithm, a type of the first vehicle, wherein the type of the first vehicle is associated with a scooter; and
determine, based on the second Fourier coefficients and the training data, using the machine learning algorithm, a type of the second vehicle, wherein the type of the second vehicle is different than the type of the first vehicle.

10. The method of claim 9, wherein the first data comprises labeled data and third Fourier coefficients, and the second data comprises labeled data and includes fourth Fourier coefficients.

11. The method of claim 9, wherein the first sensor data comprises acceleration data associated with the first vehicle.

12. The method of claim 11, wherein the method further comprises determining the acceleration data based on an x-component acceleration data, a y-component acceleration data, and a z-component acceleration data.

13. The method of claim 9, wherein the method further comprises determining third sensor data, wherein the third sensor data comprises a rotation data.

14. The method of claim 13, wherein the method further comprises determining the rotation data based on an x-component rotation data, a y-component rotation data, and a z-component rotation data.

15. The method of claim 9, wherein the machine learning algorithm includes a deep-learning algorithm.

16. The method of claim 9, wherein the machine learning algorithm includes a convolutional neural network.

17. A method, comprising:
determining, by at least one processor of a device, first sensor data received from one or more sensors associated with the device, wherein the first sensor data is associated with a vehicle and with a time domain;
determining, by the at least one processor, based on the first sensor data, second sensor data associated with a frequency domain, wherein to determine the second sensor data comprises to perform a Fourier transform on the first sensor data to determine Fourier coefficients associated with the first sensor data; and
determining, by the at least one processor, based on the Fourier coefficients, using a machine learning algorithm, a type of the vehicle, wherein the type of the vehicle is associated with a scooter.

18. The method of claim 17, wherein the first sensor data comprises acceleration data associated with the vehicle, and the method further comprises determining the acceleration data based on an x-component acceleration data, a y-component acceleration data, and a z-component acceleration data.

19. The method of claim 17, wherein the method further comprises determining third sensor data, wherein the third sensor data comprises a rotation data.

20. The method of claim 17, further comprising:
determining a portion of the first sensor data to serve as first training data;
determining third sensor data to serve as second training data; and
training the machine learning algorithm using at least one of the first training data or the second training data.
